(19) United States
(12) Patent Application Publication
(10) Pub. No.: US 2004/0163235 A1
(43) Pub. Date: Aug. 26, 2004

(54) Method of manufacturing a lithium battery as well as a lithium battery

(76) Inventors: Hans Feil, Eindhoven (NL); Martinus Jacobus Johannes Hack, Eindhoven (NL)

Correspondence Address: Philips Electronics North America Corporation, Corporate Patent Counsel, PO Box 3001, Briarcliff Manor, NY, 10510, US

(21) Appl. No.: 10/480,360

(22) PCT Filed: Jun. 17, 2002
(86) PCT No.: PCT/IB02/02317

(30) Foreign Application Priority Data
Jun. 20, 2001 (EP) 01202356.0

(51) Int. Cl. H01M 10/04

(52) U.S. Cl. 29/623.5

(57) ABSTRACT

Disclosed is a method of manufacturing a lithium battery. Said lithium battery at least comprises a stack of a negative electrode, a separator, and a positive electrode. In said method a pattern of holes is produced in the negative electrode as well as in the positive electrode. A polymeric material is applied on at least one side of the stack and the stack is subjected to heat and pressure, so that the polymeric material penetrates the holes, whereby components are stuck and pressed together. In the method described, the polymeric material comprises a polymer having a melt flow index of at least 0.5 g/10 min. at 190° C.

The invention relates to a method of manufacturing a lithium battery comprising a stack of a negative electrode, a separator, and a positive electrode, which method comprises the steps of applying negative electrode material on a negative current collector so as to form the negative electrode, applying positive electrode material on a positive current collector so as to form the positive electrode, and arranging a separator between the negative electrode and the positive electrode, and which method comprises the following steps:

a) producing a pattern of holes in the negative electrode;

b) producing a pattern of holes in the positive electrode;

applying a polymeric material on at least one side of the stack and subjecting the stack and the polymeric material to heat and pressure, so that the polymeric material penetrates the holes, whereby which the negative electrode, the positive electrode and the separator are stuck and pressed together. Moreover, the present invention relates to a lithium battery comprising a stack of a negative electrode, a separator, and a positive electrode held together by means of a polymeric material.

The growing market for lightweight, portable cordless consumer products, such as CD-players, mobile telephones, laptop computers and video cameras, has increased the need for high-density batteries. Specifically, very thin and flexible batteries are required. If an acceptable portability is to be achieved, the batteries contained in said consumer products should provide the necessary amount of energy at the smallest possible weight and volume. Lithium is a very advantageous material for use in batteries in which a high energy density at a minimum weight is required.

A method of manufacturing a lithium battery according to the preamble is known from the International patent application with publication number 00/04601.

The battery obtained by said method has thin and flexible shape and at the same time provides a very high energy density. Moreover, the contact between the electrodes and the separator is obtained and maintained in a very efficient way. The battery can be packed in a thin walled canister, as the wall of such canister is not needed for maintaining a sufficient pressure on the respective components of the battery. In one of the methods according to the International application 00/04601, a film of a polymeric material is applied to both sides of the stack, and said polymeric film is subjected to heat and pressure. As a result thereof, the polymeric material melts and penetrates into the holes. By said method a battery is obtained with polymeric material in each of the holes acting as a plug or rivet and sticking to the respective layers, causing these layers to be bonded together.

It is an object of the invention to provide a method of manufacturing a lithium battery according to the preamble which method is even more efficient and fast.

To this end, the method of manufacturing a lithium battery according to the preamble is characterized in that the polymeric material comprises a polymer having a melt flow index of at least 0.5 g/10 min. at 190° C.

By using a polymer having a melt flow index of at least 0.5 g/10 min. at 190° C. an easy flow of the melted polymer is ensured resulting in a relatively fast and substantial full penetration thereof in the holes of the respective material layers of the battery. It is noted that that the testing method used to determine the melt flow rate is ASTM D 1238.

In a particular embodiment of the invention, the polymeric material comprises a polymer having a melt flow index of at least 2.0g/10 min. at 190° C.

The use of a polymer with a melt flow rate of at least 2.0 g/10 min. at 190° C. is preferred as it provides even better results in terms of speed and completeness of penetration of the polymer.

Preferably, the polymeric material comprises a polymer having a melt flow index of at least 3.0 g/10 min. at 190° C.

At such high value of melt flow index a very fast and complete penetration of the polymeric material into the holes of the respective layers of the battery can be ensured. The use of a polymer with such high melt flow index is both useful in the manufacturing of very thin lithium batteries, as well as in the manufacturing of thicker lithium batteries comprising multiple stacks of active material. In case of the latter only a relatively small amount of polymer is necessary in order to keep the material layers together, thus providing a battery with a relative high capacity.

Advantageously, the polymeric material comprises a polymer with a melting point below 120° C.

Very often the separator of the lithium battery comprises a polyethylene separator, which is also referred to as a safety separator. The melting point of said separator is in the range of about 120-130° C. In order to prevent melting of the separator during the heat treatment, it is desirable to apply a temperature below 1 20° C., using a polymer with a melting point below said temperature.

In an advantageous embodiment of the invention, the polymeric material comprises a polymer with a melting point above 90° C.

The use of a polymer with a melting point above 90° C. prevents the formation of any damage on the battery during the tests to which batteries are usually subjected to, and which are performed at about 90° C.

Several polymers can be used in the above method according to the present inventions. Examples are polyethylene, TAFMER A-4090′ and Stamylan LD®.

Preferably, the polymeric material comprises polyethylene.

The present invention also relates to a lithium battery which is obtainable by the above method.

Finally, the present invention relates to a lithium battery comprising a stack of a negative electrode, a separator, and a positive electrode held together by means of a polymeric material. Said battery is characterized in that the polymeric material comprises a polymer having a melt flow index of at least 0.5 g/10 min. at 190° C.

The lithium battery of the invention can be used in various (cordless) appliances, for example notebook personal computers, portable CD-players, portable telephones, paging equipment, video cameras, electric shavers, electric tools, electric vehicles, and hearing aids. The lithium battery may be used as a primary or as a secondary battery.

The invention will be elucidated in greater detail by means of an exemplary embodiment and with reference to the accompanying drawings, in which

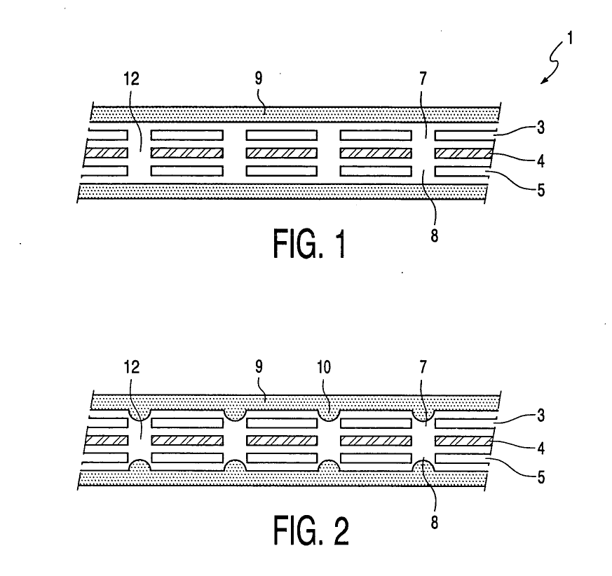

FIG. 1 diagrammatically shows a stack of a negative electrode, a separator and a positive electrode, as well as polymer foil provided on both sides of the stack; and

FIG. 2 diagrammatically shows a stack according to FIG. 1, in which the polymer foil is locally provided with bulges.

### EXEMPLARY EMBODIMENT

A mixture for the negative electrode material is prepared by mixing 6 g graphite particles having a particle size of 10 μm as the active positive material, 4.5 g carboxymethyl cellulose (1% aqueous solution) and 0.5 g styrene butadiene rubber (60% dispersion in water) as a binder, and formed into a paste to be applied as a coating onto both surfaces of a copper foil current collector. The thickness of the coating is 200 μm. The thickness of the copper foil amounts to 14 μm. The pasted current collector is pre-dried at 85° C. for 15 minutes, heat-treated at 110° C. for 3 hours, and then compressed until the thickness has become 110 μm. The negative electrode is cut out so as to be a square of 2×2 cm².

A mixture for the positive electrode material is prepared by mixing 6 g LiCoO₂ as the active positive material, 0.18 g acetylene black as a conductive material, 5 g carboxymethyl cellulose (1% aqueous solution) and 0.7 g polytetrafluoroethylene (60% dispersion in water) as a binder, and formed into a paste to be applied as a coating on both surfaces of an aluminum foil current collector. The thickness of the coating is 420 μm. The thickness of the aluminum foil amounts to 20 μm. The pasted current collector is pre-dried at 85° C. for 15 minutes, heat-treated at 250° C. for 4 hours, and then compressed until the thickness has become 100 μm. The positive electrode is cut out so as to be a square of 2×2 cm²

A 25 μm thick porous polyethylene foil is used as a separator.

The negative electrode, the positive electrode and the separator are each provided with a pattern of holes by mechanical punching. The diameter of the holes in the positive electrode preferably is about 1 mm, while the diameter of the holes in the negative electrode preferably is about 0.8 mm. Said difference in diameter is not shown in the Figures. The holes are provided in a two-dimensional array with a mutual hole distance of 5 mm.

A stack is made of the negative electrode 3, the separator 4, and the positive electrode 5. As is shown in the Figures, the negative electrode 3 is provided with holes 7, while the positive electrode 5 is provided with holes 8 and the separator is provided with holes 12. A polymer foil 9 is present at both sides of the stack 1, which polymer foil in the present example comprises polyethylene (Aldrich: [9002-88-4] Cat 42,803-5). When the stack is subjected to heat and pressure, the polyethylene will melt and will penetrate the holes in the electrodes and the separator through-and-through, thereby bonding together the electrodes and the separator.

In the same way as described above, a multilayer stack of layers can be bonded together in one step using a relatively small amount of polymer, thereby obtaining a battery of increased capacity or voltage.

In FIG. 2, a stack 1 is provided with a polymer foil 9 which is provided with bulges 10 which are located at the end of the holes in the electrodes. In the example shown in FIG. 2, Stamylan LD® is used as polymeric material. When the stack is subjected to heat and pressure, the polymeric material will melt, causing at least the bulges to penetrate into the holes, thereby bonding together the electrodes and the separator. By providing a polymer foil with bulges, the amount of polymeric material—and therefore inactive—can be reduced, which results in an increase of the capacity of the battery. The concept of bulges can also be obtained by locally providing a carries foil with bulges of polymeric material.

1. A method of manufacturing a lithium battery comprising a stack of a negative electrode, a separator, and a positive electrode, which method comprises the steps of applying negative electrode material on a negative current collector so as to form the negative electrode, applying positive electrode material on a positive current collector so as to form the positive electrode, and arranging a separator between the negative electrode and the positive electrode, and which method comprises the following steps:
a) producing a pattern of holes in the negative electrode;
b) producing a pattern of holes in the positive electrode;
applying a polymeric material on at least one side of the stack and subjecting the polymeric material to heat and pressure, so that the polymeric material penetrates the holes, whereby the negative electrode, the positive electrode and the separator are stuck and pressed together, characterized in that the polymeric material comprises a polymer having a melt flow index of at least 0.5 g/10 min. at 190° C.

2. A method of manufacturing a lithium battery as claimed in claim 1, characterized in that the polymeric material comprises a polymer having a melt flow index of at least 2.0 g/10 min. at 190° C.

3. A method of manufacturing a lithium battery as claimed in claim 1 or 2, characterized in that the polymeric material comprises a polymer having a melt flow index of at least 3.0g/10 min. at 190° C.

4. A method of manufacturing a lithium battery as claimed in one or more of claims 1-3, characterized in that the polymeric material comprises a polymer with a melting point below 120° C.

5. A method of manufacturing a lithium battery as claimed in one or more of claims 1-4, characterized in that the polymeric material comprises a polymer with a melting point above 90° C.

6. A method of manufacturing a lithium battery as claimed in claim 3, characterized in that the polymeric material comprises polyethylene.

7. Lithium battery comprising a stack of a negative electrode, a separator, and a positive electrode held together by means of a polymeric material, which battery is obtainable by a method according to any one of the preceding claims.

8. Lithium battery comprising a stack of a negative electrode, a separator, and a positive electrode held together by means of a polymeric material, characterized in that the polymeric material comprises a polymer having a melt flow index of at least 0.5 g/10 min. at 190° C.
